(19) United States
(12) Patent Application Publication
(10) Pub. No.: US 2004/0054457 A1
(43) Pub. Date: Mar. 18, 2004

(54) System for documenting the operation of an attached implement

(76) Inventor: Georg Kormann, Homburg (DE)

Correspondence Address: Kevin J. Moriarty, Patent Department, DEERE & COMPANY, One John Deere Place, Moline, IL, 61265-8098, US

(21) Appl. No.: 10/610,477

(22) Filed: Jun. 30, 2003

(30) Foreign Application Priority Data
Jul. 6, 2002 (DE) 102 30 474.2

(51) Int. Cl. G06F 19/00; G06G 7/76; G06F 7/70; G06G 7/00; G06F 17/00; G06F 7/00; G05D 3/00; G05D 1/00

(52) U.S. Cl. 701/50; 701/1

(57) ABSTRACT

A system for documenting the operation of an attached implement for a self-propelled working machine. An operating parameter detection arrangement is arranged to detect an operating parameter of the attached implement and to transmit an operating parameter signal to a memory. The memory receives the operating parameter signal and stores the operating parameter signal.

### FIELD OF THE INVENTION

The present invention is directed to a system for documenting the operation of an attached implement for a working machine.

### BACKGROUND OF THE INVENTION

Working machines, particularly agricultural machines, are frequently subject during their operation to a considerable amount of wear. In the case of a resale the price that can be obtained for such a machine depends thereby among other factors upon the number of hours of operation accrued previously. The number of hours of operation accrued is also significant for the maintenance of the service intervals and warranty questions. In the case of self-propelled machines, such as combines, forage harvesters and tractors, operating hour counters are available as a rule on the basis of which the hours of operation recorded to date can be documented, however, such arrangements do not exist for attached implements, such as front harvesting attachments, ground breaking implements or implements for the application of fertilizer, plant protection materials or seed crop.

EP 0 377 163 B proposes that a signal be transmitted to a microprocessor of a harvesting machine that contains information about the type of take-up arrangement attached to the harvesting machine. The signal is used to establish the forward propulsion velocity.

DE 101 29 136 A proposes that information about the width or the sideways limits of the take-up arrangement be supplied for the control of a harvesting machine. On the basis of this information an automatic harvested crop edge detection arrangement is controlled.

### SUMMARY OF THE INVENTION

It is an object of the present invention to provide a system for documenting the operation and condition of an attached implement for a working machine.

It is proposed that an operating parameter signal be generated by an operating parameter detection arrangement, that contains information about the operation of the attached implement. The operating parameter signal is conducted to a memory that stores operating parameter documentation information in memory, that is derived from the operating parameter signal or that corresponds to the latter.

In this way information about the operation of the attached implement is stored in memory. It can later be recalled for the detection of operating data (for example, for the calculation for contractors), for purposes of service or for a control of machine usage. In the case of a resale it is known how many hours the attached implement has been operated and/or to which loads it has been exposed.

For the recall or otherwise processing of the operating documentation from the memory a display is used. It can be connected with the memory at the same location. It may also be a separate, portable implement, that an operator or an authorized service person can carry along with him.

It is also conceivable that the display can be arranged on the working machine. In this embodiment, the display may be integrated into an existing on-board computer system of the working machine. By a corresponding input the operator can display the operating documentation information of the attached implement or the parts of it that are relevant to him. The information can also be utilized for the automatic control of the attached implement and/or the working machine or for purposes of diagnosis. If, for example, a front attachment is used that has already been operated for a relatively long period (or a front attachment for which the service interval was not kept), an automatic control can hold the forward propulsion velocity and thereby the throughput within certain limits, in order to avoid a failure of the front harvesting attachment.

Further information can be stored in the memory about the attached implement, that can be displayed by means of the display or that can be transmitted to the on-board computer system of the working machine. The information may, for example, include the model and serial number and/or the manufacturer of the attached implement. It may also identify other characteristics of the attached implement, such as its working width or appropriate drive rotational speeds. The on-board computer system can control operating parameters of the working machine and/or of the attached implement corresponding to the information transmitted by the memory.

Examples of the operating parameters that can be stored in the memory are the hours of operation, the area processed, the mechanical load on the drive-line, the operating speed, the throughput, the working machine, the type of crop harvested and characteristics of the environment, such as temperature, precipitation or information about the location of the operation, that can be detected, for example, by means of a position detection system (for example, supported by satellite) which is located as a rule on the working machine. The information about the location of the operation may be of interest to contractors for billing purposes.

Most appropriately the memory contains a non-volatile memory so that the information stored in memory is not lost after the attached implement or the working machine is shut down or in the case of a battery failure. In order to prevent manipulations the memory is preferably arranged mechanically in such a way that it cannot be manipulated without destroying it.

The operating parameter detection arrangement and/or the memory as a rule contain electronic components, that must be supplied with current. For this purpose a storage device (storage battery) may be provided as an energy transmission arrangement or a non-cable-connected (for example, an inductive) or cable bound energy transmission arrangement may be used in order to supply the aforementioned arrangements from the working machine. It would also be conceivable to buffer the memory by a simple generator driven by the working machine and/or a solar cell.

As a rule the memory is connected mechanically with the attached implement. However, it would be conceivable to arrange it separated therefrom and to arrange it, for example, with the identification data of the attached implement. For this purpose appropriate transponders could be used, that make possible a wireless transmission of data and are sufficiently small. The use of a magnetic or electronic chip card associated with the attached implement that can be inserted into a corresponding display of the working machine, would be possible. In order to assure that the data in the memory are always up to date, and to avoid that the attached implement is operated without the operation being detected, it would be conceivable that an on-board computer system of the working machine enables an operation only if a communication with the memory is possible. For this purpose a separate recognition arrangement is a solution with which the presence of an attached implement with an associated memory on the working machine can be recognized, for example, a further electronic identification element of the attached implement, that transmits a corresponding information electrically to the on-board computer of the working machine. If this recognition arrangement detects an attached implement with an external memory, operation of the attached implement is now possible due to the existence of communication with the memory. This arrangement also has advantages with respect to the protection against theft, since the attached implement on a working machine equipped in the corresponding manner without memory cannot be used.

The operating parameter detection arrangement includes sensors that may be located on the attached implement or on the working machine. As a rule one part of the sensors is located on the attached implement and another part on the working machine, where presently existing sensors (for example, for the crop throughput) can be utilized. The sensors on the attached implement can be connected by cables with the memory, if they are located on the attached implement. The sensors on the working machine can also transmit their data over cables to the memory, for which purpose a bus (CAN or LBS bus) that, as a rule, is also available, can be used, that is connected with the attached implement. The operating parameter signal can also be transmitted to the memory in a wireless manner, for example, by radio or optically.

The invention can be used by any desired attached implement of the working machine. Examples include front attachment harvesting implements of harvesting machines, straw choppers for combines, ground breaking implements, sowing implements, fertilizer spreaders for tractors or shovels for dredges.

### BRIEF DESCRIPTION OF THE DRAWINGS

FIG. 1 is a side schematic view of a harvesting machine with an attached implement in the form of a front harvesting attachment.

### DETAILED DESCRIPTION

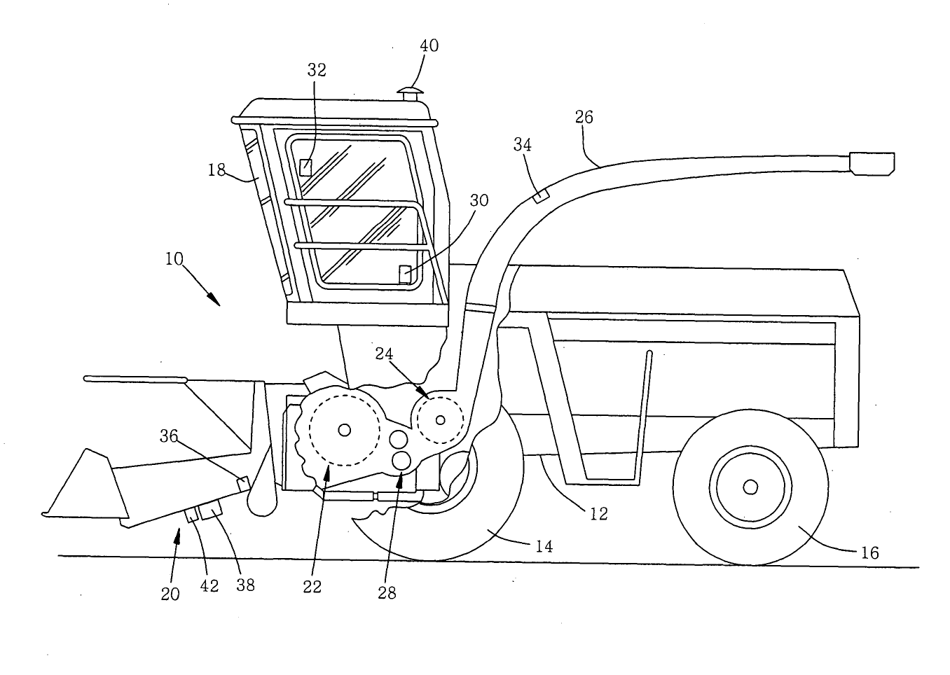

A working machine 10 shown in FIG. 1 is a self-propelled forage harvester. The working machine 10 is supported on a frame 12 that is carried on front and rear wheels 14 and 16. The working machine 10 is controlled from an operator's cab 18 from which a removable attached implement 20 in the form of a harvested crop take-up arrangement can be controlled visually. Crop taken up from the ground by the harvested crop take-up arrangement, such as corn, grass or the like is conducted to a chopper drum 22 that chops it into small pieces and delivers it to a conveying arrangement 24. The crop is directed from the harvesting machine 10 to an accompanying trailer by a discharge duct 26. Between the chopper drum 22 and the conveying arrangement 24 are conditioning rolls 28 through which the crop to be conveyed is conducted tangentially to the conveying arrangement 24.

The working machine 10 includes an on-board computer 30 that is connected over a bus, not shown, among other items with an operating and display implement 32, a throughput sensor 34, an attached implement operating sensor 36, a memory 38 and a position sensor 40. Each of these arrangements is equipped with a microprocessor or micro-controller for the data transmission over the bus.

The throughput sensor 34 includes a microwave transmitter and receiver, that are arranged in the discharge duct 26. The output signal of the throughput sensor 34 is a function of the amount of harvested crop being carried by the discharge duct 26 at the immediate time, since it measures the intensity of the radiation received by the microwave receiver. Any other type of throughput sensor could also be used such as a sensor that measures the width of the gap between interacting conditioning rolls 28.

The attached implement operating sensor 36 is an electro-mechanically, inductive or electro-optically operating sensor that detects the movement of intake arrangements of the attached implement 20 (for example, transverse screw conveyor or intake chains). It transmits a signal that contains information on whether the attached implement 20 is in the operating mode or not.

The position sensor 40 includes a satellite antenna that interacts with a satellite system, for example, the GPS system, and transmits a geo-referenced information about the immediate position of the working machine 10.

After starting the main engine of the working machine 10, as soon as the on-board computer 30 is in the operating mode, it receives signals from the throughput sensor 34, from the attached implement operating sensor 36 and from the position sensor 40 about the operating parameters of the attached implement, particularly about the throughput, the operating mode (attached implement on or off) and the position. The aforementioned arrangements including the on-board computer 30 are used as an operating parameter detection arrangement. On the basis of these operating parameter data the on-board computer 30 generates an operating parameter signal that it transmits to the non-volatile memory 38 that is supplied with current by a battery 42. There the information is stored in memory (for example, in a cycle of seconds) whether the attached implement 20 is in operation, what throughput it is processing and where it is located. This operation documentation information is available for later use. It would also be conceivable that the on-board computer 30 in addition or alternatively stores in memory only a cumulative operating documentation after the end of a harvesting process, that can be detected on the basis of the attached implement operating sensor 38, in which, for example, an average throughput, and preferably a maximum throughput, the means position and the operating time are contained.

The operating and display implement 32 makes it possible to display various operating parameters of the working machine 10 and to change them manually. It is also used as a display for the memory 38 and makes it possible to display the data stored in the memory 38. The operator can thereby recognize how many hours the attached implement 20 has operated. Furthermore the memory 38 contains information about the operating width of the attached implement 20, which the on-board computer 30 considers during the automatic establishment of the forward propulsion velocity of the working machine 10.

After the data have been transmitted from the memory 38 in a wireless manner or by means of a portable memory, for example, to an office computer, the operator can perform a billing calculation on the basis of the operating documentation information, where the position information may be helpful for the identification of the customer of a contractor. They are also used for the establishment of the area of the operation.

Having described the illustrated embodiment, it will become apparent that various modifications can be made without departing from the scope of the invention as defined in the accompanying claims.

1. A system for documenting the operation of an attached implement for a working machine, characterized by an operating parameter detection arrangement that is arranged to detect an operating parameter of the attached implement and to transmit an operating parameter signal to a memory, the memory receives the operating parameter signal and stores the operating parameter signal in memory.

2. The system as defined by claim 1 further comprising a display for displaying the operating parameter signal from the memory.

3. The system as defined by claim 2 wherein the display interacts with an on-board computer of the working machine.

4. The system as defined by claim 3 wherein additional information about the attached implement is stored in the memory.

5. The system as defined by claim 3 wherein the operating parameter signal contains information about how long the attached implement was operated.

6. The system as defined by claim 3 wherein the operating parameter signal contains information about where the attached implement was operated.

7. The system as defined by claim 3 wherein the operating parameter signal contains information about how much load the attached implement encountered.

8. The system as defined by claim 3 wherein the memory contains a non-volatile memory.

9. The system as defined by claim 3 wherein the operating parameter detection arrangement and the memory are supplied electric current from a storage battery.

10. The system as defined by claim 3 wherein the memory is arranged on the attached implement.

11. The system as defined by claim 10 wherein at least part of the operating parameter detection arrangement is arranged on the working machine and the parameter detection arrangement is connected to the memory.

12. An attached implement for a self-propelled working machine is provided with a system for documenting the operation of the attached implement, characterized by an operating parameter detection arrangement that is arranged to detect an operating parameter of the attached implement and to transmit an operating parameter signal to a memory, the memory receives the operating parameter signal and stores the operating parameter signal in memory, the memory being attached to the attached implement.

13. The attached implement as defined by claim 12 further comprising a display for displaying the operating parameter signal from the memory, the display being attached to the self-propelled working machine.

14. The attached implement as defined by claim 13 wherein the display interacts with an on-board computer of the working machine.

15. The attached implement as defined by claim 14 wherein additional information about the attached implement is stored in the memory.

16. The attached implement as defined by claim 15 wherein the working implement comprises a harvesting assembly.
